(19) United States
(12) Patent Application Publication
(10) Pub. No.: US 2024/0270620 A1
(43) Pub. Date: Aug. 15, 2024

(54) METHOD OF MANUFACTURING ULTRA-PURE WATER

(71) Applicant: SAMSUNG ELECTRONICS CO.,LTD., Suwon-si (KR)

(72) Inventors: Dasom OH, Suwon-si (KR); Changha LEE, Seoul-si (KR); Soojin Shim, Suwon-si (KR); Hyejin LEE, Seoul-si (KR); Jehun KIM, Suwon-si (KR); Jiwon LEE, Seoul-si (KR)

(73) Assignees: SAMSUNG ELECTRONICS CO.,LTD., Suwon-si (KR); SEOUL NATIONAL UNIVERSITY R&DB FOUNDATION, Seoul (KR)

(21) Appl. No.: 18/432,867

(22) Filed: Feb. 5, 2024

(30) Foreign Application Priority Data
Feb. 6, 2023 (KR) 10-2023-0015724

(51) Int. Cl. C02F 3/34; C02F 101/38; C02F 103/04

(52) U.S. Cl. CPC C02F 3/342; C02F 2101/38; C02F 2103/04; C02F 2209/02; C02F 2209/06; C02F 2209/44

(57) ABSTRACT

An ultra-pure water manufacturing method using catalyst particles includes preparing first treated water by treating urea-containing feed water with urease-immobilized catalyst particles, and removing ionic substances from the first treated water by reverse osmosis, wherein the catalyst particles on which urease is immobilized are prepared by inducing a surface of the support to have an organic functional group thereon by modifying the surface of the support, coating a linker on the surface of the support, and immobilizing urease on the support in a buffer solution having a pH in a range of about 6 to about 8.

### CROSS-REFERENCE TO RELATED APPLICATION

This application is based on and claims priority to Korean Patent Application No. 10-2023-0015724, filed on Feb. 6, 2023, in the Korean Intellectual Property Office, the disclosure of which is incorporated by reference herein in its entirety.

### BACKGROUND

The present disclosure relates to a method of manufacturing ultra-pure water, and more particularly, to a method of manufacturing ultra-pure water using urease.

Ultra-pure water used in processes for manufacturing, for example, semiconductor devices, is manufactured by removing various impurities in feed water. In general, ultra-pure water is pure water, the specific resistivity of which satisfies the range of 10 MΩ·cm to 18 MΩ·cm.

Research has been conducted into chlorine oxidation treatment for the feed water, or microbial active carbons, in order to remove urea in the feed water, but there are problems such as a long response time or an increase in process steps.

### SUMMARY

The present disclosure provides a method of manufacturing ultra-pure water by using a urease-immobilized catalyst.

According to an aspect of the present disclosure, there is provided an ultra-pure water manufacturing method using catalyst particles, the ultra-pure water manufacturing method including preparing first treated water by treating urea-containing feed water with catalyst particles on which urease is immobilized, and removing ionic substances from the first treated water by reverse osmosis, wherein the catalyst particles on which urease is immobilized are prepared by inducing a surface of a support for the catalyst particles to have an organic functional group thereon by modifying the surface of the support, coating a linker on the surface of the support, and immobilizing urease on the support in a buffer solution having a pH in a range of about 6 to about 8.

According to another aspect of the present disclosure, there is provided an ultra-pure water manufacturing method using catalyst particles, the ultra-pure water manufacturing method including preparing first treated water by treating urea-containing feed water with catalyst particles on which urease is immobilized, removing ionic substances from the first treated water by reverse osmosis, and washing and reusing the catalyst particles, wherein the catalyst particles on which urease is immobilized are prepared by inducing a surface of a support for the catalyst particles to have an organic functional group thereon by modifying the surface of the support, coating a linker on the surface of the support, and immobilizing urease on the support in a buffer solution, wherein the support has a size of about 200 mesh or more and about 3 mesh or less.

According to another aspect of the present disclosure, there is provided an ultra-pure water manufacturing method using urease-immobilized catalyst particles, the ultra-pure water manufacturing method including preparing first treated water by treating urea-containing feed water with the urease-immobilized catalyst particles, removing ionic substances from the first treated water by reverse osmosis, and washing and reusing the urease-immobilized catalyst particles, wherein the urease-immobilized catalyst particles are prepared by pre-treating active carbon having a size of about 200 mesh or more and about 3 mesh or less with nitric acid, inducing a surface of the active carbon to have an amino group thereon by modifying the surface of the active carbon pretreated with nitric acid, coating a bifunctional linker on the surface of the active carbon, and immobilizing urease on the active carbon by adding the support coated with the linker into a composition containing a buffer solution having a pH in a range of about 6 to about 8 and the urease and treating the support in a temperature range of about 4° C. to about 10° C. for about 48 hours to about 72 hours.

### BRIEF DESCRIPTION OF DRAWINGS

Embodiments will be more clearly understood from the following detailed description taken in conjunction with the accompanying drawings in which:

FIG. 1 is a schematic diagram for describing an ultra-pure water manufacturing apparatus according to embodiments;

FIG. 2 is a block diagram for describing a method of manufacturing ultra-pure water, according to embodiments;

FIG. 3 is a block diagram for describing a method of manufacturing a urease-immobilized catalyst, according to embodiments; and

FIG. 4 is a graph showing performance stability over repeated use of a urease-immobilized catalyst, according to embodiments.

### DETAILED DESCRIPTION OF EMBODIMENTS

Hereinafter, the present disclosure will be described more fully with reference to the accompanying drawings, in which embodiments of the present disclosure are shown. In the drawings, like elements are labeled with like reference numerals and repeated description thereof will be omitted.

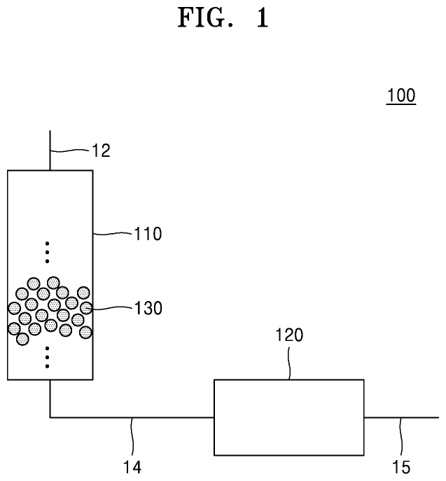

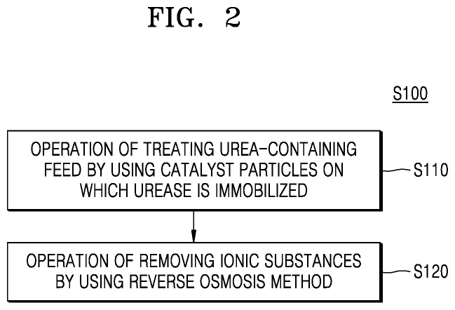

FIG. 1 is a schematic diagram for describing an ultra-pure water manufacturing apparatus 100 according to embodiments. FIG. 2 is a block diagram for describing a method of manufacturing ultra-pure water (S100), according to embodiments. In detail, FIG. 2 is a block diagram for describing a method of manufacturing ultra-pure water from feed water including urea.

Referring to FIGS. 1 and 2, the ultra-pure water manufacturing apparatus 100 may include a urea decomposition device 110 and a reverse osmosis system 120.

According to embodiments, feed water containing urea may be introduced into the urea decomposition device 110 through an inflow pipe 12. Catalyst particles 130 may be filled in the urea decomposition device 110. For example, the urea decomposition device 110 may be a packed bed reactor filled with the catalyst particles 130.

In FIG. 1, the urea decomposition device 110 composed of a single column is illustrated, but is not limited thereto. For example, the urea decomposition device 110 may include a plurality of columns connected in series or in parallel.

According to embodiments, the catalyst particles 130 may have a structure in which urease is immobilized on a support through chemical bonds. For example, the urease may be immobilized by forming a covalent bond with the support.

According to embodiments, the support may include silica and active carbon. The shape of the silica and the active carbon may include a spherical shape or a pellet shape, but the shape is not limited thereto.

In some embodiments, the support may have a size of 200 mesh or more and 3 mesh or less. In some embodiments, the support may have a size of about 140 mesh or more and about 4 mesh or less, such as 140 mesh or more and 4 mesh or less. In some embodiments, the support may have a size of about 12 mesh to about 40 mesh, such as 12 mesh to 40 mesh. When the support has a size of less than 200 mesh, the productivity of the ultra-pure water manufacturing process may decrease due to clogging of the urea decomposition device 110. When the size of the support is greater than 3 mesh, the active area of the catalyst particles 130 may be reduced, thereby inhibiting the urea decomposition reaction.

In embodiments, the catalyst particles 130 which are formed may include a linker that mediates the binding between the support and urease. For example, the linker may be a cross-linker, and may perform a function of chemically immobilizing the urease on the support by forming a covalent bond with the support and the urease.

In some embodiments, the linker may include a C2-C30 organic compound including two or more functional groups. In some embodiments, the linker may include a C2-C20 chain or ring aliphatic hydrocarbon group including two or more functional groups. The chain may include a straight chain or a branched chain. In some embodiments, the linker may include a C6-C30 aromatic hydrocarbon group including two or more functional groups.

In some embodiments, the aliphatic hydrocarbon group and/or the aromatic hydrocarbon group may be substituted or connected by at least one selected from the group consisting of —CH═CH—, —C═C—, —O—, —S—, —C(═O)—, —OC(═O)O—, —C(═O)O—, —S(═O)—, —C(═O)S—, —C(═O)NR—, —NR′—, —S—S—, and SO2, where R and R′ may each independently be a hydrogen atom, a C1-C8 straight chain or a C4-C8 branched chain hydrocarbon group.

In some embodiments, the two or more functional groups of the linker may be the same as each other, but are not limited thereto. For example, the linker may include two or more different functional groups. For example, the functional group may include a vinyl group, an epoxy group, an acrylate group, a carboxyl group, a hydroxyl group, a succinimidyl group, a maleimide group, a sulfide group, a thiol group, an amino group, and an aldehyde group, but is not limited to the above examples.

In some embodiments, the linker may include an aldehyde group. The aldehyde group of the linker may react with a distal amino group of the urease to form a covalent bond under relatively mild conditions. Accordingly, the production yield of the catalyst on which urease is immobilized may be improved, and thus the productivity of the ultra-pure water production process may be improved.

In some embodiments, the linker may include a dialdehyde-based compound. In some embodiments, the linker may include an aliphatic dialdehyde or an aromatic dialdehyde. For example, the linker may form a covalent bond by reacting with the support and the urease through aldehyde groups at both ends thereof. For example, the support may be bonded to an aldehyde group of one end of the linker, and thus, even when the linker is bonded to the urease at the other end, the covalent bond may be stably maintained.

In some embodiments, the linker may include a disuccinimidyl-based compound, and the linker may form a covalent bond by reacting with the support and the urease through each succinimidyl group at both ends.

In some embodiments, the linker may include a disuccinimidyl compound, and may include, for example, N,N′-disuccinimidyl carbonate (DSC), N,N′-disuccinimidyl tartrate (DST), N,N′-disuccinimidyl oxalate (DSO), suberic acid bis (N-hydroxysuccinimide ester), N,N′-disuccinimidyl glutarate (DSG), N,N′-disuccinimidyl suberate (DSS), N,N′-disuccinimidyl homobifunctional poly(ethylene glycol) or a combination thereof, but is not limited to the above examples.

In some embodiments, the linker may include a dialdehyde-based compound, and may include, for example, glutaraldehyde, terephthalaldehyde, phthaldialdehyde, or 2-bromoisophthalaldehyde, but is limited to the above examples.

In some embodiments, the linker may include succinimidyl-6-((b-maleimidopropionamido)hexanoate) (SMPH), succinimidyl 4-(p-maleimido-phenyl)butyrate (SMPB), sulfo-SMPB, sulfo-(N-ε-maleimidocaproyl-oxysulfosuccinimide ester), sulfo-(N-γ-maleimidobutyryl-oxysuccinimide ester), N-(α-maleimidoacetoxy)-succinimide ester (AMAS), N-(β-maleimidopropyloxy)succinimide ester (BMPS), N-ε-maleimidocaproic acid (EMCA), N-(ε-maleimidocaproyloxy)succinimide ester (EMCS), N-(γ-maleimidobutyryloxy)succinimide ester (GMBS), succinimidyl 4-(N-maleimidomethyl) cyclohexane-1-carboxy-(6-amidocaproate) (LC-SMCC), m-maleimidobenzoyl-N-hydroxysuccinimide ester (MBS), succinimdyl 3-(bromoacetamido)propionate (SBAP), N-succinimidyl iodoacetate (SIA), N-succinimidyl(4-iodoacetyl)aminobenzoate (SIAB), or a combination thereof, but is not limited to the above examples.

The method of manufacturing ultra-pure water (S100) according to the embodiments may include an operation of forming first treated water by treating feed water containing urea by using the catalyst particles 130 on which urease is immobilized (S110).

According to embodiments, urea in the feed water may contact the catalyst particles 130 in the urea decomposition device 110 and undergo a decomposition reaction according to Reaction Formula 1 below to form ammonium ions and carbonate ions. In Reaction Formula 1 below, the stoichiometric notation is omitted for convenience.

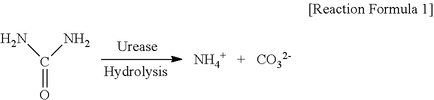

In some embodiments, the concentration of urea in the first treated water may be 20 μg/L or less. Accordingly, ultra-pure water may be manufactured without introducing an additional process for removing or treating urea. For example, the concentration of urea in the first treated water may be achieved by increasing the urea removal rate of the urea decomposition device 110, and the urea removal rate of the urea decomposition device 110 may be controlled by adjusting the size of the support, the flow rate of the feed, etc. For example, the urea removal rate of the urea decomposition device 110 may be about 80% or more, such as 80% or more, about 85% or more, such as 85% or more, or about 90% or more, such as 90% or more.

According to embodiments, ionic substances in the first treated water may be removed using a reverse osmosis method (S120). According to embodiments, the first treated water may flow into the reverse osmosis system 120 through a connection pipe 14. For example, the reverse osmosis system 120 may remove ionic substances from the first treated water by using a reverse osmosis membrane. For example, the reverse osmosis membrane may include a cellulose acetate-based membrane, a polyamide-based membrane, a polysulfonate-based membrane, and the like, but is not limited thereto.

In some embodiments, the first treated water may have a pH range of about 5 to about 9, such as a pH range of 5 to 9. In some embodiments, the first treated water may have a pH range of about 5.5 to about 8.5, such as a pH range of 5.5 to 8.5. Within the above range, ammonium ions and carbonate ions of the first treated water introduced into the reverse osmosis device 120 may be removed with high efficiency. For example, the ammonium ion removal rate and the carbonate ion removal rate may each be about 95.0% or more, such as 95.0% or more, about 97.0% or more, such as 97.0% or more, or about 99.0%, such as 99.0% or more.

According to embodiments, the reverse osmosis system 120 may form second treated water obtained by removing ionic substances from the first treated water, and the second treated water may be discharged from the reverse osmosis system 120 through a discharge pipe 15. For example, the concentration of ammonium ions in the second treated water may be 10 μg/L or less.

According to embodiments, the method of manufacturing ultra-pure water (S100) may include an operation of treating feed water containing urea by using the catalyst particles 130 on which urease is immobilized (S110), and then an operation of washing the catalyst particles 130 with distilled water and reusing the same. For example, the operation of washing the catalyst particles 130 may be performed at the same time as the operation of removing ionic substances from the first treated water by using the reverse osmosis device 120 or after removing the ionic substances from the first treated water.

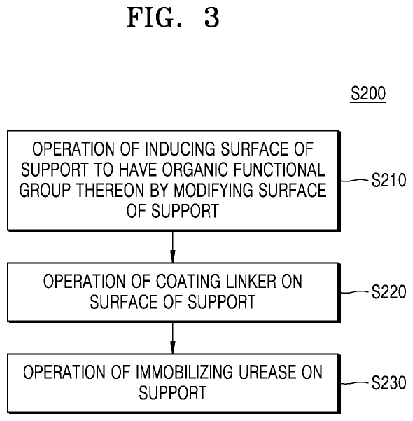

FIG. 3 is a block diagram illustrating a method of manufacturing the catalyst particles 130 on which the urease is immobilized (S200), in the method of manufacturing ultra-pure water (S100) according to embodiments. The method of manufacturing a urease-immobilized catalyst according to the embodiments (S200) may include a first operation (S210) of inducing the surface of the support to have an organic functional group thereon by modifying the surface of the support, a second operation of coating a linker on the surface of the support (S220), and a third operation of immobilizing urease on the support (S230). Hereinafter, the method of manufacturing the catalyst particles 130 described with reference to FIGS. 1 and 2 will be described in detail with reference to FIG. 3.

According to embodiments, a support may be input to a composition for surface modification, and a surface of the support may be modified to induce the surface of the support to have an organic functional group thereon (S210). According to embodiments, the composition for surface modification may include a silane coupling agent having an organic functional group at a distal end thereof and an organic solvent.

In some embodiments, the support may be active carbon, and in this case, a pretreatment process for forming CO bonds on the surface of the support may be performed. In some embodiments, the support may be treated with an aqueous solution of nitric acid (HNO₃).

In some embodiments, nitric acid in the aqueous solution of nitric acid may have a mass percentage of about 20% to about 50%, such as 20% to 50%, and the active carbon may be treated in the aqueous solution of nitric acid in a temperature ranging from about 25° C. to about 80° C., such as 25° C. to 80° C., for about 12 hours to about 24 hours, such as for 12 hours to 24 hours. In some embodiments, nitric acid may be included in the aqueous solution of nitric acid in an amount of about 40 parts by weight to about 50 parts by weight based on the total weight of the aqueous solution of nitric acid, such as 40 parts by weight to 50 parts by weight based on the total weight of the aqueous solution of nitric acid, and treated in a temperature range of about 70° C. to about 80° C., such as 70° C. to 80° C., for about 12 hours to about 24 hours, such as for 12 hours to 24 hours. When the pretreatment process is performed within the above range, the C—O bond on a surface of the active carbon may increase and easily react with the silane coupling agent.

In some embodiments, the support may be silica, and in this case, the above-described pretreatment process may be omitted.

According to embodiments, the support may be subjected to reflux cooling treatment (reflux) for about 12 hours to about 24 hours, such as for 12 hours to 24 hours, in a temperature range of about 10° C. to about 30° C., such as 10° C. to 30° C., in the composition for surface modification. For example, by the reflux cooling method, the evaporated organic solvent may be liquefied and recovered as a liquid organic solvent, and thus, the concentration of the silane coupling agent in the composition for surface modification may be maintained relatively constant.

In some embodiments, the organic functional group of the silane coupling agent may include a mercapto group, an isocyanate group, an amino group, an acrylate group, an epoxy group, and a vinyl group, but is not limited thereto.

In some embodiments, the silane coupling agent may be an organo-alkoxysilane. For example, the silane coupling agent may include two or three methoxy groups or ethoxy groups. For example, the support may have a hydroxy group on a surface thereof, and an alkoxy group of the silane coupling agent may be hydrolyzed to react with the hydroxy group on the surface of the support to form a bond. Accordingly, the organic functional group of the silane coupling agent may be exposed on the surface of the support.

In some embodiments, the silane coupling agent may include vinyltrimethoxysilane, vinyltriethoxysilane, 3-glycidoxypropyl methyldimethoxysilane, 3-glycidoxypropyl trimethoxysilane, 3-glycidoxypropyl methyldiethoxysilane, 3-glycidoxypropyl triethoxysilane, p-styryltrimethoxysilane, 3-methacryloxypropyl methyldimethoxysilane, 3-methacryloxypropyl trimethoxysilane, 3-methacryloxypropyl methyldiethoxysilane, 3-methacryloxypropyl triethoxysilane, N-2-(aminoethyl)-3-aminopropyl methyldimethoxysilane, N-2-(aminoethyl)-3-aminopropyl trimethoxysilane, 3-aminopropyltriethoxysilane, N-phenyl-3-aminopropyl trimethoxysilane, 3-mercaptopropyl methyldimethoxysilane, 3-mercaptopropyl trimethoxysilane, 3-isocyanatepropyltriethoxysilane, or a combination thereof.

In some embodiments, the organic solvent of the composition for surface modification may include at least one of an ether, alcohol, glycol ether, aromatic hydrocarbon compound, ketone, and ester, but is not limited thereto. For example, the organic solvent for the composition for surface modification may include ethylene glycol monomethyl ether, ethylene glycol monoethyl ether, methyl cellosolve acetate, ethyl cellosolve acetate, diethylene glycol methyl ether, diethylene glycol ethyl ether, propylene glycol, propylene glycol methyl ether (PGME), propylene glycol methyl ether acetate (PGMEA), propylene glycol ethyl ether, propylene glycol ethyl ether acetate, propylene glycol propyl ether acetate, propylene glycol butyl ether, propylene glycol butyl ether acetate, ethanol, propanol, isopropyl alcohol, isobutyl alcohol, 4-methyl-2-pentanol (which may alternatively be written as methyl isobutyl carbinol (MIBC)), hexanol, 1-methoxy-2-propanol, 1-ethoxy-2-propanol, ethylene glycol, propylene glycol, heptanone, propylene carbonate, butylene carbonate, toluene, xylene, methyl ethyl ketone, cyclopentanone, cyclohexanone, ethyl 2-hydroxypropionate, ethyl 2-hydroxy-2-methylpropionate, ethyl ethoxyacetate, ethyl hydroxyethylacetate, methyl 2-hydroxy-3-methylbutanoate, methyl 3-methoxymethylpropionate, methyl 3-methoxyethylpropionate, ethyl 3-ethoxyethylpropionate, methyl 3-ethoxyethylpropionate, methyl pyruvate, ethyl pyruvate, ethyl acetate, butyl acetate, ethyl lactate, butyl lactate, gamma-butyrolactone, methyl 2-hydroxyisobutyrate, methoxybenzene, n-butyl acetate, 1-methoxy-2-propyl acetate, methoxyethoxy propionate, ethoxyethoxy propionate, or a combination thereof.

In some embodiments, a content of the silane coupling agent based on the total weight of the composition for surface modification may be about 0.1 parts by weight to about 15 parts by weight, such as 0.1 parts by weight to 15 parts by weight. A content of the organic solvent relative to the total weight of the composition for surface modification may be about 85 parts by weight to about 99.9 parts by weight, such as 85 parts by weight to 99.9 parts by weight. A content of the support added may be about 1 part by weight to about 30 parts by weight based on the total weight of the composition for surface modification, such as 1 part by weight to 30 parts by weight based on the total weight of the composition for surface modification.

According to embodiments, the surface-modified support may be added to a linker coating composition, and a linker may be coated on the surface of the support (S220). According to embodiments, the linker coating composition may include a linker and an organic solvent. The linker may be understood to be the same as that described in the method of manufacturing ultra-pure water (S100) described with reference to FIGS. 1 and 2.

In some embodiments, an organic functional group of the silane coupling agent may be an epoxy group, and a functional group of the linker may include at least one of an amino group, a hydroxyl group, and a carboxylic acid group.

In some embodiments, the organic functional group of the silane coupling agent may be an amino group, and the functional group of the linker may include an aldehyde group.

In some embodiments, the support may be treated in the composition for surface modification (S210), and then filtered and recovered, and then added to the linker coating composition. For example, the filtration and recovery may include washing the surface-modified support with the organic solvent and removing the organic solvent remaining after washing, through drying.

In some embodiments, the organic solvent of the linker coating composition may include at least one of an ether, alcohol, glycol ether, aromatic hydrocarbon compound, ketone, and ester, but is not limited thereto. For example, the organic solvent of the linker coating composition may include ethylene glycol monomethyl ether, ethylene glycol monoethyl ether, methyl cellosolve acetate, ethyl cellosolve acetate, diethylene glycol methyl ether, diethylene glycol ethyl ether, propylene glycol, propylene glycol methyl ether (PGME), propylene glycol methyl ether acetate (PGMEA), propylene glycol ethyl ether, propylene glycol ethyl ether acetate, propylene glycol propyl ether acetate, propylene glycol butyl ether, propylene glycol butyl ether acetate, ethanol, propanol, isopropyl alcohol, isobutyl alcohol, 4-methyl-2-pentanol, hexanol, 1-methoxy-2-propanol, 1-ethoxy-2-propanol, ethylene glycol, propylene glycol, heptanone, propylene carbonate, butylene carbonate, toluene, xylene, methyl ethyl ketone, cyclopentanone, cyclohexanone, ethyl 2-hydroxypropionate, ethyl 2-hydroxy-2-methylpropionate, ethyl ethoxyacetate, ethyl hydroxyethylacetate, methyl 2-hydroxy-3-methylbutanoate, methyl 3-methoxymethylpropionate, methyl 3-methoxyethylpropionate, ethyl 3-ethoxyethylpropionate, methyl 3-ethoxyethylpropionate, methyl pyruvate, ethyl pyruvate, ethyl acetate, butyl acetate, ethyl lactate, butyl lactate, gamma-butyrolactone, methyl 2-hydroxyisobutyrate, methoxybenzene, n-butyl acetate, 1-methoxy-2-propyl acetate, methoxyethoxy propionate, ethoxyethoxy propionate, or a combination thereof.

In some embodiments, the content of the linker relative to the total weight of the linker coating composition may be about 0.1 parts by weight to about 20 parts by weight, such as 0.1 parts by weight to 20 parts by weight. The content of the organic solvent relative to the total weight of the linker coating composition may be about 80 parts by weight to about 99.9 parts by weight, such as 80 parts by weight to 99.9 parts by weight. The content of the surface-modified support added to the linker coating composition may be about 1 part by weight to about 40 parts by weight based on the total weight of the linker coating composition, such as 1 part by weight to 40 parts by weight based on the total weight of the linker coating composition.

According to embodiments, the surface-modified support may be reflux-cooled for about 1 hour to about 3 hours, such as for 1 hour to 3 hours, in a temperature range of about 10° C. to about 30° C., such as 10° C. to 30° C., in the linker coating composition. In some embodiments, the surface-modified support may be subjected to reflux cooling treatment in the linker coating composition for about 1.5 hours to about 2.5 hours, such as for 1.5 hours to 2.5 hours. For example, when the surface-modified support is treated in the linker coating composition for less than 1.5 hours, the number of linkers bonded to the organic functional group of the surface-modified support may be significantly reduced. For example, when the surface-modified support is treated in the linker coating composition for more than 2.5 hours, the immobilization rate of urease in a subsequent operation of urease immobilization (S230) may be reduced due to mutual interference and crosslinking between the linkers.

In some embodiments, the functional group at one end of the linker may react with an organic functional group of the surface-modified support to form a covalent bond, and the functional group at the other end of the linker may be exposed on the surface of the support. For example, the functional group at the other end of the linker may form a covalent bond with the functional group of urease in the subsequent operation of urea immobilization (S230).

According to embodiments, urease may be immobilized on the support coated with the linker by injecting the support coated with the linker into a composition for urease immobilization (S230). According to embodiments, the other end of the linker, which is opposite to the one end thereof coupled to the support, may be bonded to urease, and thus, the urease may be immobilized on the support to form the catalyst particles 130. For example, the catalyst particles 130 may include a composite having a [support/silane coupling agent/linker/urease] structure.

In some embodiments, the surface-modified support may be treated in the linker coating composition (S220), filtered and collected, and then added to the composition for urease immobilizing. For example, the filtration and recovery may include washing the linker-coated support by using distilled water and drying the washed linker-coated support in a temperature range of about 40° C. to about 50° C., such as 40° C. to 50° C., for 10 hours or more.

According to embodiments, the composition for urease immobilization may include urease and a buffer solution.

In some embodiments, the buffer solution may include phosphate buffer (PB), phosphate buffered saline (PBS), or triethylammonium acetate, but is not limited thereto.

According to embodiments, the buffer solution may have a pH in a range of about 6 to about 8, such as a pH in a range of 6 to 8. When an immobilization reaction of urease is performed within the above range, a change in pH according to the immobilization reaction of the urease may be prevented, and the formation of a hydroxyl group on the surface of the support may be suppressed. Thus, urea removal performance may not deteriorate even when catalyst particles on which urease is immobilized are repeatedly washed with distilled water and reused. For example, the buffer solution may have a pH in a range of about 6.5 to about 7.5, such as a pH in a range of 6.5 to 7.5.

In some embodiments, the operation of immobilizing urease on the support (S230) may include injecting the linker-coated support into a buffer solution in which urease is dissolved.

In some other embodiments, the composition for urease immobilization may include an organic solvent, urease, and a buffer solution. In this case, the operation of immobilizing urease on the support (S230) may be adding the linker-coated support to an organic solvent in which urease is dissolved, and allowing the urease and the linker-coated support to react with each other, and at the same time, adding and titrating a buffer solution in divided amounts.

According to embodiments, the linker-coated support may be treated in the composition for urease immobilization in a temperature range from about 4° C. to about 10° C., such as from 4° C. to 10° C., for 48 hours or more. For example, the linker-coated support may be treated for about 48 hours to about 72 hours, such as for 48 hours to 72 hours, in a temperature range from about 4° C. to about 6° C., such as from 4° C. to 6° C., in the composition for urease immobilization. Accordingly, denaturation of urease may be prevented, and lifespan characteristics of the catalyst particles 130 may be improved.

Thereafter, the catalyst particles 130 on which urease is immobilized may be filtered, washed with a buffer solution and distilled water, and dried in a temperature range from about 4° C. to about 6° C., such as from 4° C. to 6° C.

In the method of manufacturing ultra-pure water (S100) according to embodiments, urease may be removed with high efficiency at the front end of the process by using the catalyst particles 130 on which urease is immobilized, and accordingly, ultraviolet irradiation or the like at the rear end may be omitted. A method of manufacturing the catalyst particles 130 according to embodiments may include immobilizing urease on a support in a pH range near neutral (S130), and thus, the lifespan characteristics of the catalyst particles 130 according to the washing and repeated use thereof may be improved.

Hereinafter, experimental examples including embodiments are presented to help understanding of the present disclosure, but these are merely illustrative of the present disclosure, and the present disclosure is not limited to the following examples.

### PREPARATION EXAMPLE

### 1) Preprocessing Operation

Under reflux conditions, 3 g of 12 to 40 mesh GAC (manufactured by Kuraray) was added to a nitric acid (50%) solution and reacted at 80° C. for 12 hours, and then the oxidized GAC was washed with distilled water and dried at 105° C. to obtain a first compound.

### 2) Surface Modification Operation

The first compound was added to 80 ml of toluene solution into which 2 ml of APTMS is injected, and stirred for 12 hours under reflux conditions. Then, amine-derivatized GAC was washed with dichloromethane and ethanol and dried to obtain a second compound.

### 3) Linker Coating Operation

The second compound was added to an ethanol solution having a glutaraldehyde content of 5% by weight and reacted for 2 hours under reflux conditions, and then the linker-coated GAC was washed with distilled water and dried at 45° C. to 50° C. for 10 hours to obtain a third compound.

### 4) Urease Immobilization Operation

The third compound was added to 50 ml PB (Phosphate Buffer) (0.1 M, pH 7) buffer solution containing 150 mg of urease (Canavalia ensiformis (Jack bean), 50,000-100,000 units/g) and stirred at 4° C. for 48 days. Then, the GAC on which urease was immobilized was washed with the PB solution and washed once more with distilled water to obtain catalyst particles on which urease is immobilized.

### Experimental Example

Reactants containing 66 μM of urea were stirred for 120 minutes in a batch reactor containing catalyst particles (30 g/L urease-GAC) synthesized according to the Preparation Example, and the catalyst particles were washed with distilled water every cycle.

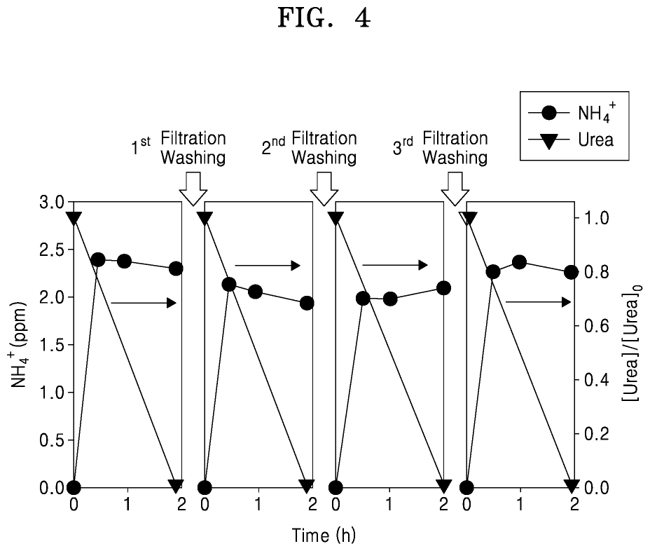

FIG. 4 shows the urea content and the ammonium ion content with time. Referring to FIG. 4, when ultra-pure water was prepared using the catalyst particles prepared according to the embodiments, it was confirmed that urea was decomposed within a relatively short time from a relative point of view, and the urea removal efficiency was maintained stably even despite washing and repeatedly using the catalyst particles.

While the present disclosure has been particularly shown and described with reference to embodiments thereof, it will be understood that various changes in form and details may be made therein without departing from the spirit and scope of the following claims.

What is claimed is:

1. An ultra-pure water manufacturing method using catalyst particles, the ultra-pure water manufacturing method comprising:
preparing first treated water by treating urea-containing feed water with catalyst particles on which urease is immobilized; and
removing ionic substances from the first treated water by reverse osmosis,
wherein the catalyst particles on which urease is immobilized are prepared by:
inducing a surface of a support for the catalyst particles to have an organic functional group thereon by modifying the surface of the support;
coating a linker on the surface of the support; and
immobilizing urease on the support in a buffer solution having a pH in a range of about 6 to about 8.

2. The ultra-pure water manufacturing method of claim 1, further comprising washing and reusing the catalyst particles after preparing the first treated water with the catalyst particles.

3. The ultra-pure water manufacturing method of claim 1, wherein the first treated water has a urea concentration in a range of 20 μg/L or less.

4. The ultra-pure water manufacturing method of claim 1, wherein the first treated water has a pH in a range of about 5 to about 9.

5. The ultra-pure water manufacturing method of claim 1, wherein the modifying of the surface of the support comprises adding the support into a composition containing a silane coupling agent and an organic solvent and subjecting the support to reflux cooling.

6. The ultra-pure water manufacturing method of claim 5, wherein the silane coupling agent comprises an amino group.

7. The ultra-pure water manufacturing method of claim 1, wherein the linker comprises a dialdehyde-based compound or a disuccinimidyl-based compound.

8. The ultra-pure water manufacturing method of claim 1, wherein the support comprises silica.

9. The ultra-pure water manufacturing method of claim 1, wherein the support comprises active carbon,
the ultra-pure water manufacturing method further comprising pre-treating the active carbon with nitric acid before the modifying of the surface of the active carbon to have an organic functional group thereon.

10. The ultra-pure water manufacturing method of claim 9, wherein the pre-treating of the active carbon with nitric acid comprises
treating the active carbon in an aqueous solution of nitric acid in a temperature range of about 70° C. to about 80° C., and
a content of nitric acid in the aqueous solution of nitric acid is from about 40 parts by weight to about 50 parts by weight based on the total weight of the aqueous solution of nitric acid.

11. An ultra-pure water manufacturing method using catalyst particles, the ultra-pure water manufacturing method comprising:
preparing first treated water by treating urea-containing feed water with catalyst particles on which urease is immobilized;
removing ionic substances from the first treated water by reverse osmosis; and
washing and reusing the catalyst particles,
wherein the catalyst particles on which urease is immobilized are prepared by:
inducing a surface of a support for the catalyst particles to have an organic functional group thereon by modifying the surface of the support, wherein the support has a size of about 200 mesh or more and about 3 mesh or less;
coating a linker on the surface of the support; and
immobilizing the urease on the support in a buffer solution.

12. The ultra-pure water manufacturing method of claim 11, wherein the coating of a linker on the surface of the support comprises adding the support into a composition containing a linker and an organic solvent and subjecting the support to reflux cooling in a temperature range of about 10° C. to about 30° C. for about 1 hour to about 3 hours.

13. The ultra-pure water manufacturing method of claim 11, wherein the immobilizing of the urease on the support comprises adding the support coated with the linker into a composition containing a buffer solution having a pH in a range of about 6 to about 8 and the urease and treating the support in a temperature range of about 4° C. to about 10° C. for about 48 hours to about 72 hours.

14. The ultra-pure water manufacturing method of claim 11, wherein the modifying of the surface of the support comprises
adding the support into a composition containing a silane coupling agent and an organic solvent and subjecting the support to reflux cooling
wherein the silane coupling agent comprises N-2-(aminoethyl)-3-aminopropyl methyldimethoxysilane, N-2-(aminoethyl)-3-aminopropyl triethoxysilane, 3-aminopropyltriethoxysilane, or N-phenyl-3-aminopropyl trimethoxysilane.

15. The ultra-pure water manufacturing method of claim 11, wherein
the linker comprises N,N′-disuccinimidyl carbonate, N,N′-disuccinimidyl tartrate, N,N′-disuccinimidyl oxalate, suberic acid bis (N-hydroxysuccinimide ester), N,N′-disuccinimidyl glutarate, N,N′-disuccinimidyl suberate, N,N′-disuccinimidyl polyethylene glycol, glutaraldehyde, terephthalaldehyde, phthaldialdehyde, or 2-bromoisophthalaldehyde.

16. The ultra-pure water manufacturing method of claim 11, wherein the first treated water has a urea concentration in a range of 20 μg/L or less.

17. An ultra-pure water manufacturing method using urease-immobilized catalyst particles, the ultra-pure water manufacturing method comprising:
preparing first treated water by treating urea-containing feed water with urease-immobilized catalyst particles;
removing ionic substances from the first treated water by reverse osmosis; and
washing and reusing the urease-immobilized catalyst particles,
wherein the urease-immobilized catalyst particles are prepared by:
pre-treating active carbon having a size of about 200 mesh or more and about 3 mesh or less with nitric acid;
inducing a surface of the active carbon to have an amino group thereon by modifying the surface of the active carbon pretreated with nitric acid;
coating a bifunctional linker on the surface of the active carbon; and
immobilizing urease on the active carbon by adding the support coated with the linker into a composition containing a buffer solution having a pH in a range of about 6 to about 8 and the urease and treating the support in a temperature range of about 4° C. to about 10° C. for about 48 hours to about 72 hours.

18. The ultra-pure water manufacturing method of claim 17, wherein the pre-treating of the active carbon with nitric acid comprises treating the active carbon in an aqueous solution of nitric acid in a temperature range of about 70° C. to about 80° C.,
wherein a content of nitric acid in the aqueous solution of nitric acid is about 40 parts by weight to about 50 parts by weight based on the total weight of the aqueous solution of nitric acid.

19. The ultra-pure water manufacturing method of claim 17, wherein the modifying of the surface of the active carbon pretreated with nitric acid comprises
adding the active carbon pretreated with nitric acid to a composition containing a silane coupling agent and an organic solvent and subjecting the active carbon to reflux cooling in a temperature range of about 10° C. to about 30° C. for about 12 hours to about 24 hours.

20. The ultra-pure water manufacturing method of claim 17, wherein the coating of a linker on the surface of the surface-modified active carbon comprises
adding the surface-modified active carbon to a composition containing a linker and an organic solvent and subjecting the surface-modified active carbon to reflux cooling for about 1 hour to about 3 hours in a temperature range of about 10° C. to about 30° C.
